(19) United States
(12) Patent Application Publication
(10) Pub. No.: US 2026/0098571 A1
(43) Pub. Date: Apr. 9, 2026

(54) POWER TRANSMISSION BELTS WITH ALIGNED REINFORCEMENT ELEMENTS

(71) Applicant: GATES CORPORATION, Denver, CO (US)

(72) Inventors: Thomas S. Moss, III, Englewood, CO (US); Bill Buchholz, Siloam Springs, AR (US); Kyle Spring, Denver, CO (US)

(73) Assignee: GATES CORPORATION, Denver, CO (US)

(21) Appl. No.: 19/113,282

(22) PCT Filed: Sep. 18, 2023
(86) PCT No.: PCT/US2023/033052

§ 371 Date: Mar. 19, 2025

Related U.S. Application Data
(60) Provisional application No. 63/408,071, filed on Sep. 19, 2022.

(51) Int. Cl. F16G 5/20; F16G 5/08

(52) U.S. Cl. CPC F16G 5/20; F16G 5/08

(57) ABSTRACT

Described herein are various embodiments of power transmission belts having regions proximate the side walls of the power transmission belts where reinforcement elements within the regions are oriented parallel to the side walls. In some embodiments, the power transmission belt has a plurality of radially inwardly extending ribs that are aligned in parallel with direction of travel of the belt. The ribs are made of an elastomer material having reinforcement elements distributed throughout. In regions proximate the side walls of each rib, the reinforcement elements (which have an aspect ratio greater than 1 to thereby provide a long axis) are oriented in parallel to the side wall. In other embodiments, the power transmission belt has generally trapezoidal cross-section including a first side wall and a second sidewall opposite the first side wall. In regions proximate each side wall of the belt, high aspect ratio reinforcement elements that are embedded in the elastomer material making up the base portion of the belt are oriented in parallel to the closest side wall.

This application claims priority to U.S. Provisional Ser. No. 63/408,071, filed Sep. 19, 2022, the entirety of which is hereby incorporated by reference.

### BACKGROUND

Power transmission belts (such as V-belts, Micro-V belts, and continuous variable transmission (CVT) belts) that rely on friction and wedging to transmit power between pulleys require certain physical properties to perform their intended function. Included in those properties are attributes such as: tensile strength, which is primarily attributed to the tensile cord embedded within the belt; axial stiffness, primarily derived from the modulus in the with-grain direction of fiber-loaded rubber layers; and bending stiffness, driven by belt thickness and the modulus in the cross-grain direction of fiber-loaded rubber layers. These properties contribute to the ability of the power transmission belt to transfer load from one pulley to another via tension in the belt spans, as well as to support the belt cordline, thus keeping it straight (planar) while under tension in the various pulleys.

To transmit load (torque) from the prime mover to the belt and from the belt to the driven mechanisms, the belt must withstand shear loading transmitted via friction from the pulley sidewall to the belt sidewall. These shear loads can contribute to distortion and ultimately failure of the belt if the shear modulus of the belt is insufficient. Additionally, belts are often subject to varying levels of pulley misalignment which may result in belt instability and turn over. Furthermore, as belts encounter the “forced strain” induced by bending around pulleys of varying diameter, the cross-section can be distorted to varying degrees impacting power transmission capability and belt wear. FIG. 1 provides a high-level description of some of the forces imposed on the belt cross section during operation.

In view of the above, a need exists for belts having improved physical properties as discussed above to thereby provide improved power transmission belts.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, a power transmission belt is described, the power transmission belt generally including a plurality of ribs aligned in parallel with the direction of travel of the power transmission belt and each rib projecting radially inwardly. Each rib includes a first side wall, a second side wall generally opposite the first side wall, and a contact surface adjoining a radial inner end of the first side wall to a radial inner end of the second side wall. The material of the plurality of ribs generally includes an elastomer material and a plurality of reinforcement elements distributed throughout the elastomer material. Each reinforcement element has an aspect ratio greater than 1 such that each reinforcement element has a long axis. The long axis of reinforcement elements located less than 5% of the width of the contact surface from the first side wall is oriented parallel to the first side wall, and the long axis of reinforcement elements located less than 5% of the width of the contact surface from the second side wall is oriented parallel to the second side wall. In other embodiments, the long axis of reinforcement elements located less than 10% of the width of the contact surface from the first side wall is oriented parallel to the first side wall, and the long axis of reinforcement elements located less than 10% of the width of the contact surface from the second side wall is oriented parallel to the second side wall.

In some embodiments, a power transmission belt is described, the power transmission belt generally including a first side wall, a second side wall generally opposite the first side wall, a backing surface adjoining a radial outer end of the first side wall to a radial outer end of the second side wall, and a contact surface generally opposite the backing surface and adjoining a radial inner end of the first side wall to a radial inner end of the second side wall. The width of the backing surface may be greater than the width of the contact surface such that the cross-section of the belt has a generally trapezoid shape. The base material of the belt generally includes an elastomer material and a plurality of reinforcement elements distributed throughout the elastomer material. Each reinforcement element has an aspect ratio greater than 1 such that each reinforcement element has a long axis. The long axis of reinforcement elements located less than 5% of the width of the contact surface from the first side wall is oriented parallel to the first side wall, and the long axis of reinforcement elements located less than 5% of the width of the contact surface from the second side wall is oriented parallel to the second side wall. In still further embodiments, In other embodiments, the long axis of reinforcement elements located less than 10% of the width of the contact surface from the first side wall is oriented parallel to the first side wall, and the long axis of reinforcement elements located less than 10% of the width of the contact surface from the second side wall is oriented parallel to the second side wall.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is an illustration of forces that may be imposed on a power transmission belt in operation as known in the prior art.

FIG. 2A is a perspective view of a section of a power transmission belt according to various embodiments described herein.

FIG. 2B is a cross-sectional view of a power transmission belt according to various embodiments described herein.

FIG. 3A is perspective view of a section of a power transmission belt according to various embodiments described herein.

FIG. 3A is a cross-sectional view of a power transmission belt according to various embodiments described herein.

FIG. 4 is a perspective view of a power transmission belt according to various embodiments described herein.

FIGS. 5A-5C are a series of cross-sectional views of various steps in a process of manufacturing a power transmission belt according to various embodiments described herein.

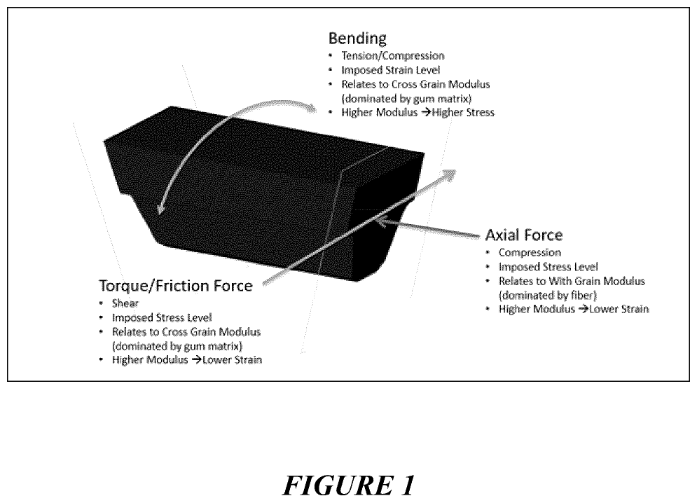

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

Described herein are various embodiments of power transmission belts wherein reinforcement elements distributed throughout a main material of the belt (e.g., an elastomer base of the belt) have a specific orientation in specific regions. More specifically, reinforcement elements having a long axis are aligned generally in parallel with side walls of the belt or ribs of the belt in regions proximate the side walls. The specific type of power transmission belt is generally not limited, and may include, e.g., V-belts, Micro V-belts and CVT belts. Similarly, additional features that may be included in the power transmission belts are generally not limited. For example, the power transmission belt may include tensile cords, textile wraps, backing layers, surface layers, etc. The power transmission belts described may also be produced with or without notches on the inner and/or outer circumference of the power transmission belt.

The oriented reinforcement materials will have higher tensile strength and modulus than the surrounding base material of the belt (e.g., rubber matrix). The orientation of these reinforcement materials provide increased shear modulus of the composite, thereby reducing strain induced from a given application of torque. The orientation of the reinforcing elements as described herein may also provide a catenary structure that increases support for tensile cords embedded in the belt. The reinforcement element orientation described herein may also be utilized to advantage by modifying the cross-sectional distortion caused by bending around pulleys.

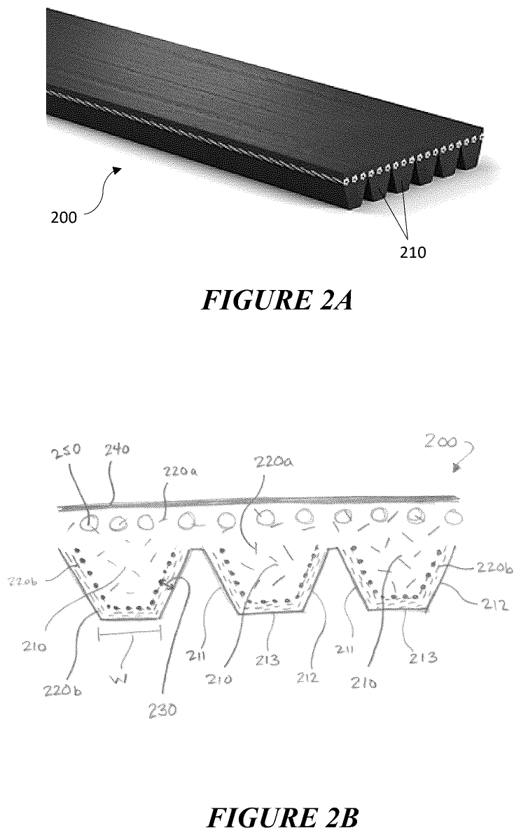

With reference to FIGS. 2A and 2B, a first embodiment of a power transmission belt incorporating the reinforcement element orientation features described herein is illustrated. The power transmission belt 200 shown in FIGS. 2A and 2B has a generally Micro-V belt configuration in which the belt 200 includes multiple ribs 210 disposed along the width of the belt 200, with each rib 210 being aligned generally in parallel with the direction of travel of the belt 200. As shown most clearly in FIG. 2B, each rib 210 includes a first side wall 211, a second side wall 212 located generally opposite the first side wall 211, and a contact surface 213 adjoining the radial inner end of the first side wall 211 and the second side wall 212. The contact surface 213 has a width W which generally defines the width of the rib 210 at its inner radial end. As also shown in FIGS. 2A and 2B, the second side wall 212 of a rib 210 and the first side wall 211 of an adjacent rib 210 generally define a groove formed between the adjacent ribs 210.

The specific shape, size and dimensions of various features of the belt 200 are generally not limited, and may be selected based on the specific application of the belt 200. This applies to both features of the belt overall (e.g., belt circumference and width) and individual features of components of the belt 200. For example, the specific shape of each rib 210, as well as the height and width of each rib 210, is generally not limited. In some embodiments, each rib 210 in belt 200 is generally identical such that each rib 210 will have the generally identical shape and dimensions. In some embodiments, the width W of the rib 210 at the radially inner end of the rib 210 (i.e., the width W of the contact surface 213) will be smaller than the width of the rib 210 at is radially out end (i.e., where the rib 210 meets the base portion of the belt 200) such that the rib 210 has a generally trapezoidal shape. The specific number of ribs 210 included on the belt 200 is also not limited, nor is the specific shape, size or dimensions of the grooves formed between adjacent ribs 210.

The base material of the belt 200, which includes the material of the ribs 210, is generally an elastomer material. Any suitable elastomer material or combination of materials can be used. Exemplary, though non-limiting, elastomers that can be used for the base material of the belt 200 include natural rubber, styrene-butadiene rubber (SBR), chloroprene rubber (CR), ethylene propylene elastomers (EPDM and EPM) and other ethylene-elastomer copolymers such as ethylene butene (EBM), ethylene pentene and ethylene octene (EOM), hydrogenated nitrile butadiene rubber (HNBR), and fluoroelastomers (FKM).

Reinforcement elements 220a, 220b are dispersed throughout the elastomer material of the belt 200, including the ribs 210, to thereby provide added reinforcement and strength to the belt 200 and components thereof. The amount of reinforcement elements distributed throughout the elastomer material is generally not limited. In some embodiments, the reinforcement elements account for about 5 to about 30 wt. % of the base material of the belt 200.

The specific type of reinforcement element 220a, 220b used is generally not limited, provided that the reinforcement element has an aspect ratio greater than 1 such that each reinforcement element 220a, 220b has a long axis. In some embodiments, the aspect ratio of each reinforcement element 220a, 220b is in the range of from about 10 to about 250 such that the reinforcement elements have a generally elongated shape. In some embodiments, the reinforcement elements 220a, 220b are chopped fibers or platy filler materials. When chopped fibers are used for the reinforcement elements 220a, 220b, the chopped fibers may be, for example, aramid, polyester (PET), cotton or nylon. The chopped fibers may be made from either organic or synthetic material, or a mixture of organic and synthetic materials. The chopped fiber material may also be in the form of carbon fiber nanotubes. Regardless of the material of the reinforcement elements 220a, 220b, the specific dimensions of the reinforcement elements 220a, 220b are generally not limited. In some embodiments, the reinforcement elements have a length in the range of from 0.2 mm to 3 mm.

As illustrated in FIG. 2B, the reinforcement elements 220a located away from the side walls 211, 212 are generally oriented in a random manner. That is to say, in the general middle portion of each rib 210, the reinforcement elements 220a are oriented in a multitude of directions. In contrast, in regions 230 proximate side walls 211, 212, the reinforcement elements 220b are generally oriented in parallel to the side wall 211, 212 to closest to the reinforcement element 220b in question. Thus, as shown in FIG. 2B, reinforcement elements 220b located in a region 230 proximate the first side wall 211 are oriented in parallel to the first side wall 211, while reinforcement elements 220b located in a region 230 proximate the second side wall 212 are oriented in parallel to the second side wall 212.

In some embodiments, the width of region 230, which is bounded on one side by the side wall 211, 212, is defined as a percentage of the width W of the contact surface. For example, in some embodiments, all reinforcement elements 220b located within a distance that is 5% of the width W of the contact surface 213 from the first side wall 211 are oriented in parallel to the first side wall 211. Thus, if the contact surface 213 has a width W that is 20 mm, then all reinforcement elements 220b within 1 mm of the side wall 211 will be oriented parallel to the side wall 211. The specific percentage of the width W of contact surface 213 that defines region 230 within which the reinforcement elements 220b are oriented parallel to the side wall 211, 212 is generally not limited. In some examples, the width of region 230 may be 5%, 10%, 15%, 25% or more of the width W of the contact surface 213.

As also shown in FIG. 2B, the density of reinforcement elements 220b within region 230 may be greater than the density of reinforcement elements 220a outside of region 230. In some embodiments, the density of reinforcement elements 220b within region 230 is 2×, 3×, 4× or more the density of reinforcement elements 220b outside of region 230. The increased density of reinforcement elements 220b within regions 230 can increase the toughness and modulus of the outer layer of belt 200.

Belt 200 may include additional features. For example, as shown in FIGS. 2A and 2B, belt 200 further includes a backing layer 240 protecting the back side (i.e. outer circumference of the belt 200. Belt 200 may also include a plurality of tensile cords 250 embedded within the base portion of the belt 200 (i.e., the portion of belt 200 between the back surface and the ribs 210). The tensile cords 250 are generally spaced across the width of the belt 200 and are oriented generally in parallel with the direction of travel of the belt 200.

FIG. 2B further illustrates that, in some embodiments, reinforcement elements 220b in the region proximate the contact surface 213 may also be oriented generally parallel to the contact surface 213. As with reinforcement elements 220b located in regions proximate the first side wall 211 and the second side wall 212, the region proximate the contact surface 213 within which the reinforcement elements 220b may be aligned in parallel to the contact surface 213 may be defined by a percentage of the width of the contact surface 213. In such embodiments, all reinforcement elements 220b located within, e.g., 5% of the width W of contact surface 213 from the contact surface 213 may be oriented parallel to the contact surface 213. Other percentages of the width W of contact surface 213 can also be used to define the region bordering the contact surface where reinforcement elements 220b are oriented parallel to the contact surface 213, such as 10% of width W, such as 15% of width W, 25% of width W, or more.

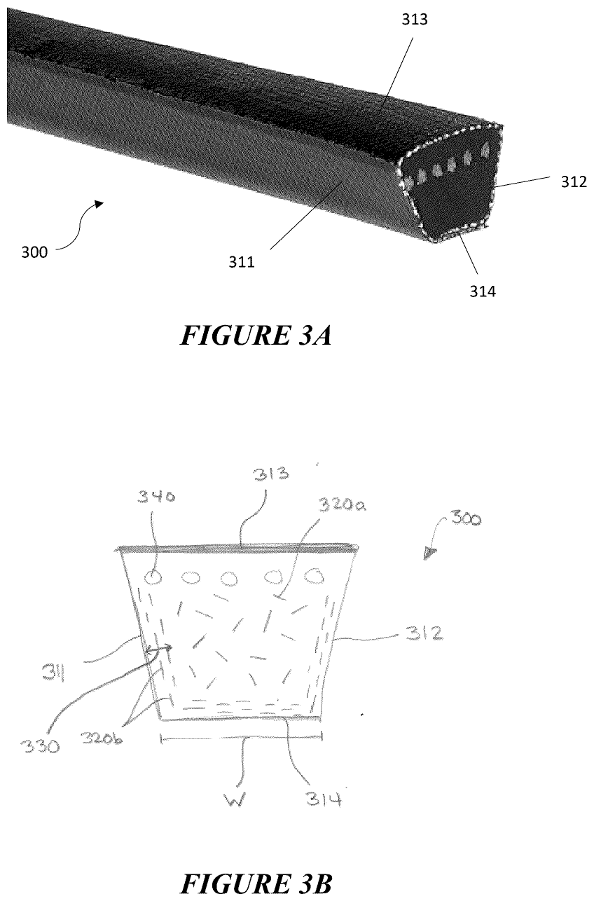

With reference to FIGS. 3A and 3B, an alternative type of belt to the belt 200 shown in FIGS. 2A and 2B but which shares many of the same features described previously is illustrated. For example, the power transmission belt 300 shown in FIGS. 3A and 3B may be a V-belt power transmission belt which has a generally trapezoidal cross-sectional shape, but which does not include multiple ribs as are included in the Micro-V belt shown in FIGS. 2A and 2B. Instead, the belt 300 shown in FIGS. 3A and 3B generally includes a first side wall 311, a second side wall 312 generally opposite the first side wall 311, a backing surface 313 adjoining the radial outer ends of the first side wall 311 and the second side wall, and a contact surface 314 generally opposite the backing surface 313 and adjoining the radial inner ends of the first side wall 311 and the second side wall 312. The specific dimensions (e.g., width, thickness, circumference, etc.) of the belt 300 is generally not limited, though in some embodiments, the width W of contact surface 314 is less than the width of the backing surface 313 to thereby provide the generally trapezoidal cross-section shape previously mentioned.

Similar to belt 200, the base material of belt 300 is generally an elastomer having reinforcement elements 320a, 320b distributed throughout the elastomer material. The specific elastomer or combination of elastomers used for the base material of belt 300 is similar or identical to the list of elastomers described previously. The specific type of reinforcement element 320a, 320b is similar or identical to the reinforcement elements 220a, 220b described previously with respect to belt 200. In some embodiments, the reinforcement elements 320a, 320b generally have an aspect ratio greater than 1, such as in the range of about 10 to about 250, such that the reinforcement elements 320a, 320b have an elongated shape with a long axis. In some embodiments, the reinforcement elements 320a, 320b are platy filler or chopped fibers of the type described in greater detail previously.

Reinforcement elements 320a located in the generally central region of the belt 300 are randomly oriented. In contrast, reinforcement element 320b in regions proximate the side walls 311, 312 are oriented in parallel with the respective side wall 311, 312. As with the embodiments described previous with respect to FIGS. 2A and 2B, the regions proximate the first and second side wall 311, 312 within which reinforcement elements are oriented parallel to the side wall can be defined based on a percentage of the width W of the contact surface 314. Thus, in some embodiments, all reinforcement elements 320b located within, e.g., 5%, 10%, 15%, or 25% of the width W of the contact surface 314 from the first and second side walls 311, 312 are oriented in parallel with the closest side wall 311, 312.

Similar to belt 200, the regions proximate the side walls 311, 312 in belt 300 where the reinforcement elements 320b are oriented parallel to the closest side wall 311, 312 may have a higher density of reinforcement elements 320b than in central region where reinforcement elements 320a are randomly oriented.

Also similar to belt 200, reinforcement elements 320b located in a region proximate the contact surface 314 may be oriented parallel to the contact surface 314. The region proximate the contact surface 314 within which reinforcement elements 320b are oriented parallel to the contact surface 314 may have a width (measured from the contact surface 314 and extending inwardly into the belt 300) that is a percentage of the width W of the contact surface 314, such as 5%, 10%, 15% or 25% of the width W of contact surface 314.

Belt 300 may further include additional power transmission belt features, such as a backing layer formed on backing surface 313, and/or tensile cords 340 embedded within the belt 300 in a location proximate the backing surface 313.

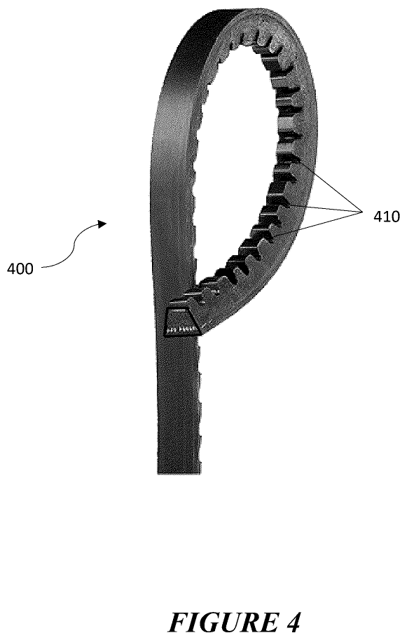

Another feature that may be included in the power transmission belt described herein, including in either the embodiment shown in FIGS. 2A and 2B or the embodiment shown in FIGS. 3A and 3B, is notches formed the front or back surface of the belt. FIG. 4 illustrates an alternative embodiment of the V-belt 300 shown in FIGS. 3A and 3B. FIG. 4 also illustrates a V-belt 400, but further illustrates that notches 410 are formed on the interior surface (i.e., contact surface) of the belt 400. The notches 410 are evenly spaced along the length of the interior surface of the belt 400 and extend inwardly from the interior surface (i.e., towards the backing surface). The notches 410 also extend the width of the belt. Such notches may be located on the interior surface, on the exterior surface, or both. In embodiments where notches are formed in both the interior surface and the exterior surface, the shape, size and/or spacing of the notches formed in the interior surface need not be identical to the shape, size and/or spacing of the notches formed in the exterior surface. For example, the interior surface may have larger and therefore fewer notches than the notches formed in the exterior surface.

Power transmission belts as described herein may include a textile wrapping wrapped or otherwise formed over some or all of the belt. Such wrapping, such as continuous textile wrapping wrapped around the outer surface of a belt, may provide a level of torsional stiffness, which provides stability to the belt. The use of reinforcement elements oriented parallel to side walls and/or contact surfaces in regions proximate the side walls and/or contact surface may provide an increased level of torsional stability. In some embodiments, the increased level of torsional stability provided by the oriented reinforcement elements may obviate the need for a textile wrapping such that the power transmission belt is a textile wrapping-free power transmission belt.

For notched belt embodiments, the oriented reinforcement element design may allow for a contiguous layer of reinforcing fabric or film to be applied to the working surfaces of the belt and the notches. This provides for reinforcement of both the sidewall surface and the notch to resist cracking. The oriented reinforcement element design of the belt may also allow for re-orientation of textile or films during the molding process such that a beneficial orientation of the surface covering is achieved.

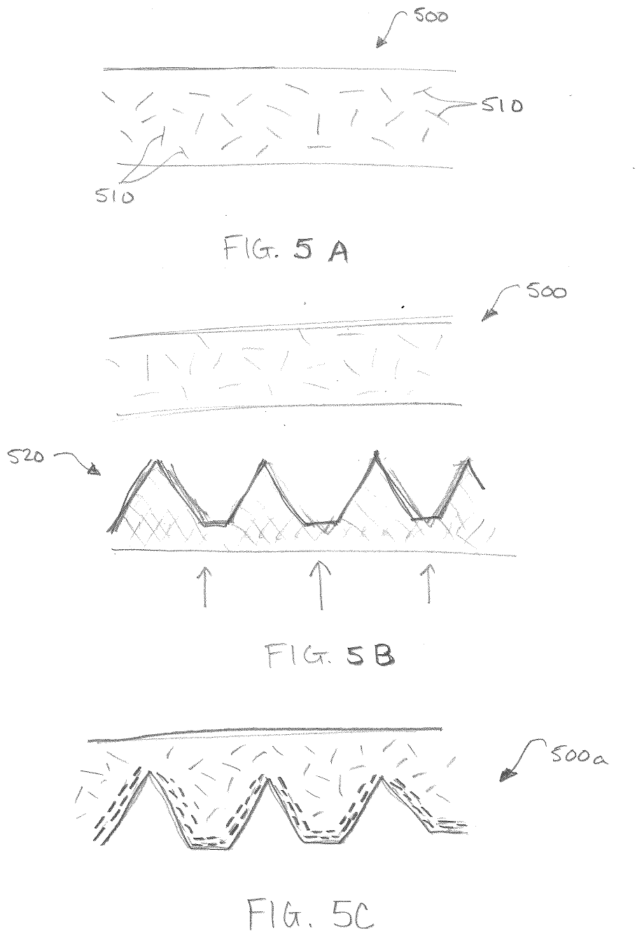

With reference now to FIGS. 5A to 5C, a general illustration of the method for forming embodiments of the power transmission belt described herein is illustrated. In FIG. 5A, a slab 500 of base material for use in forming a power transmission belt is shown. The slab 500 is generally comprised of an elastomer material or materials having a plurality of elongated reinforcement elements 510 distributed therein. As shown in FIG. 5A, the reinforcement elements (e.g., chopped fibers having an aspect ratio in the range of from 10 to 250) are oriented randomly throughout the slab 500. The slab also includes two generally planar major surfaces: an outer surface that will serves as the backing surface of the belt and an inner surface that will serve as the contact surface of the belt and into which ribs may be formed.

FIG. 5B illustrates a mold 520 being moved towards the interior surface of the slab 500. The mold 520 has a profile generally equivalent to the profile of the ribs to be formed in the interior surface of the slab 500. Any conventional molding techniques can be used to form ribs or other desired surface features in the interior surface of the slab 500. In some embodiments, the application of heat and/or pressure with the mold 520 helps to ensure that the interior surface of the slab 500 is molded into the profile of the mold 520 when the mold 520 is brought into contact with the interior surface of the slab 500.

As part of the molding process using mold 520 and the formation of ribs in the interior surface of the slab 500 by virtue of depressing the mold 520 into the interior surface of the slab 500, the reinforcement elements 510 located closest to the interior surface of the slab 500 reorient during the molding process such that they begin to align with the orientation of the walls being formed in the slab 500 via the mold profile. Thus, as the mold forms the side walls of the ribs being formed in slab 500, the reinforcement elements 510 closest to the newly formed sidewalls reorient to be aligned generally in parallel with the side walls. As such, the resulting belt 500a shown in FIG. 5C after withdrawal of the mold 520 includes reinforcement elements 510 that are aligned in parallel with the side walls and/or contact surfaces of the ribs that were formed in the slab 500.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/We claim:

1. A power transmission belt, comprising:
a plurality of ribs aligned in parallel with the direction of travel of the power transmission belt, each rib projecting radially inwardly, and each rib comprising:
a first side wall;
a second side wall generally opposite the first side wall; and
a contact surface adjoining a radial inner end of the first side wall to a radial inner end of the second side wall, the contact surface having a width;
wherein the material of the plurality of ribs comprises:
an elastomer material; and
a plurality of reinforcement elements distributed throughout the elastomer material, each reinforcement element having an aspect ratio greater than 1 such that each reinforcement element has a long axis;
wherein the long axis of reinforcement elements located less than 10% of the width of the contact surface from the first side wall is oriented parallel to the first side wall, and the long axis of reinforcement elements located less than 10% of the width of the contact surface from the second side wall is oriented parallel to the second side wall.

2. The power transmission belt of claim 1, wherein the long axis of reinforcement elements located less than 15% of the width of the contact surface from the first side wall is oriented parallel to the first side wall, and the long axis of reinforcement elements located less than 15% of the width of the contact surface from the second side wall is oriented parallel to the second side wall.

3. The power transmission belt of claim 1, wherein the long axis of reinforcement elements located less than 25% of the width of the contact surface from the first side wall is oriented parallel to the first side wall, and the long axis of reinforcement elements located less than 25% of the width of the contact surface from the second side wall is oriented parallel to the second side wall.

4. The power transmission belt of claim 1, wherein the elastomer material comprises one or more of natural rubber, styrene-butadiene rubber (SBR), chloroprene rubber (CR), ethylene propylene elastomers, ethylene-elastomer copolymers, hydrogenated nitrile butadiene rubber (HNBR), and fluoroelastomers.

5. The power transmission belt of claim 1, wherein the reinforcement elements are chopped fibers or platy fillers.

6. The power transmission belt of claim 1, wherein the long axis of reinforcement elements located less than 5% of the width of the contact surface from the contact surface is oriented parallel to the contact surface.

7. The power transmission belt of claim 1, wherein each rib includes a plurality of notches evenly spaced along the length of the rib, each notch extending into the rib from the contact surface and spanning the width of the rib.

8. The power transmission belt of claim 1, wherein the power transmission belt further comprises a plurality of tensile cords aligned in parallel with the direction of travel of the power transmission belt, the plurality of tensile cords located radially outside of the plurality of ribs.

9. The power transmission belt of claim 1, wherein the aspect ratio of the reinforcement elements is in the range of from 10 to 250.

10. The power transmission belt of claim 1, wherein the density of reinforcing elements in the region less than 5% of the width of the contact surface from the first side wall and in the region less than 5% of the width of the contact surface from the second side wall is greater than the density of reinforcement elements outside these regions.

11. A power transmission belt, comprising:
a first side wall;
a second side wall generally opposite the first side wall;
a backing surface adjoining a radial outer end of the first side wall to a radial outer end of the second side wall, the backing surface having a width; and
a contact surface generally opposite the backing surface and adjoining a radial inner end of the first side wall to a radial inner end of the second side wall, the contact surface having a width;
wherein the width of the backing surface is greater than the width of the contact surface; and
wherein the base material of the belt comprises:
an elastomer material; and
a plurality of reinforcement elements distributed throughout the elastomer material, each reinforcement element having an aspect ratio greater than 1 such that each reinforcement element has a long axis;
wherein the long axis of reinforcement elements located less than 5% of the width of the contact surface from the first side wall is oriented parallel to the first side wall, and the long axis of reinforcement elements located less than 5% of the width of the contact surface from the second side wall is oriented parallel to the second side wall.

12. The power transmission belt of claim 11, wherein the long axis of reinforcement elements located less than 15% of the width of the contact surface from the first side wall is oriented parallel to the first side wall, and the long axis of reinforcement elements located less than 15% of the width of the contact surface from the second side wall is oriented parallel to the second side wall.

13. The power transmission belt of claim 11, wherein the long axis of reinforcement elements located less than 25% of the width of the contact surface from the first side wall is oriented parallel to the first side wall, and the long axis of reinforcement elements located less than 25% of the width of the contact surface from the second side wall is oriented parallel to the second side wall.

14. The power transmission belt of claim 11, wherein the elastomer material comprises one or more of natural rubber, styrene-butadiene rubber (SBR), chloroprene rubber (CR), ethylene propylene elastomers, ethylene-elastomer copolymers, hydrogenated nitrile butadiene rubber (HNBR), and fluoroelastomers.

15. The power transmission belt of claim 11, wherein the reinforcement elements are chopped fibers or platy fillers.

16. The power transmission belt of claim 11, wherein the long axis of reinforcement elements located less than 5% of the width of the contact surface from the contact surface is oriented parallel to the contact surface.

17. The power transmission belt of claim 11, wherein the belt includes a plurality of notches evenly spaced along the length of the belt, each notch extending into the belt from the contact surface and spanning the width of the belt.

18. The power transmission belt of claim 11, wherein the power transmission belt further comprises a plurality of tensile cords aligned in parallel with the direction of travel of the power transmission belt, the plurality of tensile cords located proximate the backing surface.

19. The power transmission belt of claim 11, wherein the aspect ratio of the reinforcement elements is in the range of from 10 to 250.

20. The power transmission belt of claim 11, wherein the density of reinforcing elements in the region less than 5% of the length of the contact surface from the first side wall and in the region less than 5% of the length of the contact surface from the second side wall is greater than the density of reinforcement elements outside these regions.
